(19) United States
(12) Patent Application Publication
(10) Pub. No.: US 2006/0248474 A1
(43) Pub. Date: Nov. 2, 2006

(54) Method for displaying menu items on menu screen with improved convenience

(75) Inventor: Kenji Kimotsuki, Osaka (JP)

Correspondence Address: OSHA LIANG L.L.P., 1221 MCKINNEY STREET, SUITE 2800, HOUSTON, TX, 77010, US

(73) Assignee: Funai Electric Co., Ltd., Daito-shi (JP)

(21) Appl. No.: 11/412,550

(22) Filed: Apr. 27, 2006

(30) Foreign Application Priority Data
Apr. 27, 2005 (JP) 2005-129899 (P)

(51) Int. Cl. G06F 17/00

(52) U.S. Cl. 715/810

(57) ABSTRACT

When there is a key operation, the number of times of selection or the number of times of cancellation corresponding to the command or the menu item for which the key operation was made is rewritten. When a “enter” (select) button is depressed for selection, the count for the number of times of selection is incremented by 1. When a “return” button is depressed for selection, the count for the number of times of cancellation is incremented by 1. The number of times of execution is obtained by subtracting the number of times of cancellation from the number of times of selection, and the display order is set in accordance with the number of times of execution thus obtained.

### BACKGROUND OF THE INVENTION

1. Field of the Invention

The present invention relates to a display screen of an electronic apparatus, and more particularly to a display of menu items at the time when a user performs setting of an electronic apparatus on a display screen.

2. Description of the Background Art

An electronic apparatus is normally provided with a great number of characteristic functions and capabilities designed to satisfy the needs of users at all levels of expertise. Particularly, these functions are selected, activated or modified using the menu items incorporated in the electronic apparatus.

A user accesses the menu screen to select any function or option available in the electronic apparatus. The menu screen, however, often has settings that are complex or difficult for the user who uses it for the first time.

With the increased complexity of the functions in the electronic apparatus, the number of menu items to be selected from the menu screen tends to increase, leading to a more complex menu system.

Further, the screen size of the electronic apparatus, which is normally small, increases the complexity in navigating by selecting the menu items from the menu screen.

When accessing a menu screen, a user often needs to repeatedly select the menu items from among those prepared in a plurality of screens of different hierarchical levels until he/she can select the menu item for setting a desired function.

Meanwhile, the menu items are usually arranged on the menu screen in a fixed manner. The frequency of use of the menu items by the user does not necessarily coincide with the arrangement order of the menu items. The user may feel inconvenience with such fixed arrangement order of the menu items.

Thus, it is desirable that in an electronic apparatus, the order of arrangement of menu items on the menu screen can be changed to conform to the needs of the user.

Japanese Patent Laying-Open Nos. 2002-237968 and 2004-096725 each disclose a configuration where the order of arrangement of menu items on a menu screen is changeable in accordance with the state of use.

They each disclose the method for setting the order of arrangement of the menu items according to the number of times of selection of each menu item as an index of frequency of use. However, the user may not always select an appropriate menu item with a single operation. That is, the user may make a wrong decision or make an erroneous operation in selecting the menu item from among those arranged in a plurality of menu screens in complicated hierarchical levels.

With the conventional methods, the order of arrangement will be set based solely on the frequency of use, or the number of times of selection, which may include the number of times counted when the menu item is selected due to such wrong decision or erroneous operation.

### SUMMARY OF THE INVENTION

The present invention has been made to solve the above-described problems. An object of the present invention is to provide a method for displaying menu items on a menu screen with increased convenience by taking account of the case where a user selects the menu item by wrong decision or erroneous operation as well.

A menu item display method according to the present invention is for displaying a plurality of menu items associated with setting of an electronic apparatus and arranged in a plurality of hierarchical levels by dynamically applying priorities to the menu items in each of the hierarchical levels. The method includes the steps of: selecting, in an upper hierarchical level in the plurality of hierarchical levels, a desired menu item from among a plurality of menu items arranged in a prescribed display order to move to a lower hierarchical level; canceling selection of the selected menu item to move from the lower hierarchical level back to the upper hierarchical level as required; recording execution frequency information provided for each hierarchical level and including the number of times of selection and the number of times of cancellation of each of a plurality of menu items in the corresponding hierarchical level on a storage unit provided in the electronic apparatus; updating, for each hierarchical level, the setting of the display order of the plurality of menu items in the relevant hierarchical level based on the execution frequency information corresponding to the plurality of menu items stored in the storage unit; and displaying, for each hierarchical level, the plurality of menu items associated with the setting of the electronic apparatus in accordance with the updated display order. The execution frequency information further includes the number of times of execution obtained by subtracting the number of times of cancellation from the number of times of selection of the menu item. The step of updating includes the step of updating the setting of the display order of the plurality of menu items in each hierarchical level in descending order of the number of times of execution in the execution frequency information for each of the menu items. The step of displaying includes the step of displaying a menu item among the plurality of menu items of which the number of times of cancellation in the execution frequency information is not smaller than a prescribed number, by setting at least one of size and color of the menu item to be different from the size or the color of the remaining menu items of which the number of times of cancellation in the execution frequency information is smaller than the prescribed number.

Another menu item display method according to the present invention is for displaying a plurality of menu items associated with setting of an electronic apparatus and arranged in a plurality of hierarchical levels by dynamically applying priorities to the menu items in each of the hierarchical levels. The method includes the steps of: selecting, in an upper hierarchical level in the plurality of hierarchical levels, a desired menu item from among a plurality of menu items arranged in a prescribed display order to move to a lower hierarchical level; canceling selection of the selected menu item to move from the lower hierarchical level back to the upper hierarchical level as required; recording execution frequency information provided for each hierarchical level and including the number of times of selection and the number of times of cancellation of each of a plurality of menu items in the corresponding hierarchical level on a storage unit provided in the electronic apparatus; updating, for each hierarchical level, the setting of the display order of the plurality of menu items in the relevant hierarchical level based on the execution frequency information corresponding to the plurality of menu items stored in the storage unit; and displaying, for each hierarchical level, the plurality of menu items associated with the setting of the electronic apparatus in accordance with the updated display order.

Preferably, the execution frequency information further includes the number of times of execution obtained by subtracting the number of times of cancellation from the number of times of selection of the menu item, and the step of updating includes the step of updating the setting of the display order of the plurality of menu items in each hierarchical level in descending order of the number of times of execution in the execution frequency information for each menu item.

Preferably, the step of updating includes the step of updating the setting of the display order of the plurality of menu items such that two of the menu items of which the number of times of cancellation in the execution frequency information is not smaller than a prescribed number are not arranged adjacent to each other.

Preferably, the step of displaying includes the step of displaying a menu item among the plurality of menu items of which the number of times of cancellation in the execution frequency information is not smaller than a prescribed number, by setting at least one of size and color of the menu item to differ from the size or the color of the remaining menu items of which the number of times of cancellation in the execution frequency information is smaller than the prescribed number.

The menu item display method according to the present invention updates setting of the display order of a plurality of menu items associated with setting of an electronic apparatus in each hierarchical level based on execution frequency information including the number of times of selection and the number of times of cancellation of each menu item, and displays the plurality of menu items in accordance with the updated display order. Since the setting of the display order is performed based on the execution frequency information including the number of times of cancellation, it is possible to display the menu items on a menu screen with improved convenience by taking account of the case where the menu item is selected due to wrong decision or erroneous operation by the user.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a schematic block diagram of an electronic apparatus according to an embodiment of the present invention.

FIG. 2 shows an example of a menu screen according to the embodiment of the present invention.

FIG. 3 shows menu items in a menu screen provided in a tree shape.

FIG. 4 is a flowchart illustrating a menu item display method according to the embodiment of the present invention.

FIG. 5 shows a command count table according to the embodiment of the present invention.

FIG. 6 shows the state where menu items in the second hierarchical level concerning the setup are displayed according to the updated command count table.

FIG. 7 shows another command count table according to the embodiment of the present invention.

FIG. 8 shows the state where menu items are displayed based on the display order according to the command count table shown in FIG. 7.

FIG. 9 shows yet another command count table according to the embodiment of the present invention.

FIG. 10 is a flowchart illustrating another display order setting method according to the embodiment of the present invention.

FIG. 11 shows the state where menu items are arranged according to the display order in the command count table in FIG. 9.

### DESCRIPTION OF THE PREFERRED EMBODIMENTS

Hereinafter, an embodiment of the present invention will be described in detail with reference to the drawings. In the drawings, the same or corresponding portions have the same reference characters allotted, and description thereof will not be repeated.

Herein, a DVD information recording and reproduction apparatus will be explained as an example of the electronic apparatus.

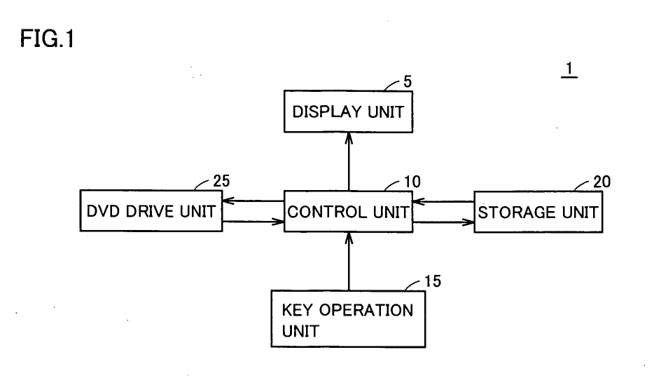

Referring to FIG. 1, the electronic apparatus 1 according to the embodiment of the present invention includes a display unit 5 having an LCD (liquid crystal display) or the like and for displaying information, a control unit 10 for controlling the entire electronic apparatus 1, a key operation unit 15 for a user to perform a key operation to select a desired function or cancel the function or the like, a storage unit 20 having a storage region of various control programs and necessary information for electronic apparatus 1, and a DVD drive unit 25 for driving a DVD (digital versatile disk) that is a recording medium. Storage unit 20 has a command count table, which will be described later, for storing the number of times of selection, the number of times of cancellation and others by the key operations of key operation unit 15. Control unit 10, in response to the key operation of key operation unit 15 associated with the command count table of storage unit 20, counts the number of times of selection, the number of times of cancellation and others and stores them in the command count table.

Hereinafter, description will be made mainly about the way of changing the arrangement order of menu items provided on a setting screen (menu screen) for selecting various functions of electronic apparatus 1. It is assumed that storage unit 20 prestores information about the menu screen and the menu items.

When a user uses key operation unit 15 to input a prescribed command, control unit 10 accepts the prescribed command input, and reads information regarding the menu screen from storage unit 20, and causes display unit 5 to display the menu screen.

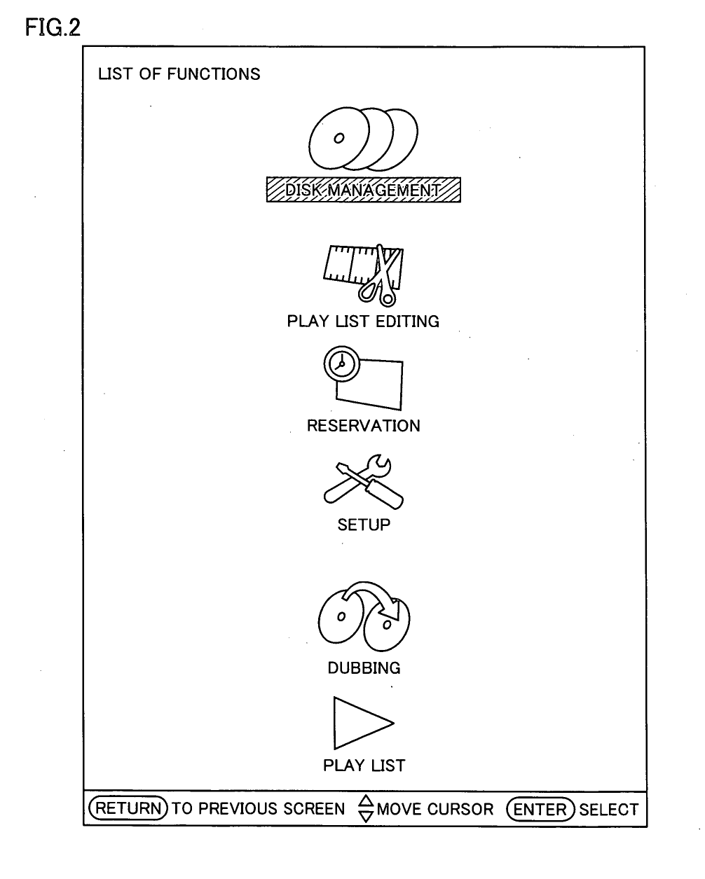

Referring to FIG. 2, the menu screen according to the embodiment of the present invention has a list of various functions displayed together with corresponding icons. Here, six menu items of “disk management”, “play list editing”, “reservation”, “setup”, “dubbing”, and “play list” are displayed by way of example.

It is assumed that the command cursor is currently pointed at “disk management” to temporarily select the item. When the user wants to perform setting or modification on any of the six menu items displayed on the menu screen, he/she needs to move the cursor that is movable in the vertical direction to a desired menu item and input a select command. Here, it is assumed by way of example that depressing a button indicated as “enter” (not shown) in key operation unit 15 allows the input of the select command. Further, depressing a button indicated as “return” (not shown) in key operation unit 15 allows moving back to the previous screen. Although the depression of the button indicated as “enter” or “return” is described herein, the present invention is applicable to any button input (key operation) having a similar function.

When the “return” button is depressed while a screen of an uppermost layer is displayed in the menu screen, the setting screen is cancelled to return to a normal display screen.

The menu screen shown is a screen having a plurality of menu items displayed thereon. It is assumed that the menu screen is divided into a plurality of hierarchical levels. For example, it is set such that, when one of a plurality of menu items is selected, a plurality of menu items are displayed in a similar manner in the layer immediately beneath the item.

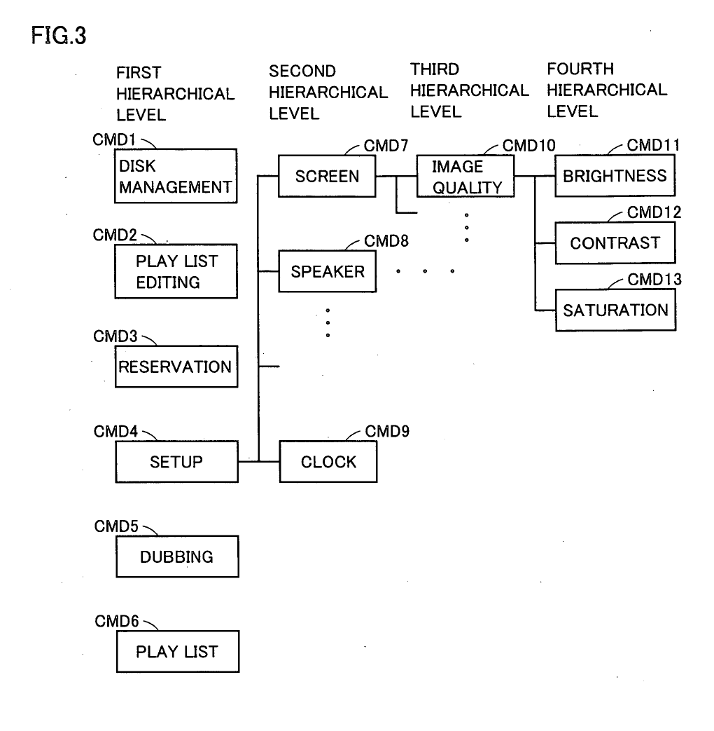

Referring to FIG. 3, menu items of the first through fourth hierarchical levels, provided in a tree shape, are shown by way of example. For example, in the first hierarchical level, the above-described six menu items, “disk management” (CMD 1), “play list editing” (CMD 2), “reservation” (CMD 3), “setup” (CMD 4), “dubbing” (CMD 5), and “play list” (CMD 6) are displayed. Further, for the menu item of “setup”, for example, “screen” (CMD 7), “speaker” (CMD 8), . . . , “clock” (CMD 9) are displayed as the second hierarchical level. When menu item “screen” (CMD 7) is selected, for example, menu items in the third hierarchical level are displayed. For example, a menu item “image quality” (CMD 10) is displayed. When menu item “image quality” (CMD 10) is selected, menu items in the fourth hierarchical level are displayed. Specifically, a menu item “brightness” (CMD 11), a menu item “contrast” (CMD 12), and a menu item “saturation” (CMD 13) are displayed by way of example.

Here, when the “enter” (select) button is depressed, the screen moves from the upper layer to the lower layer, as explained above in conjunction with FIG. 2. When the “return” button is depressed, the screen moves from the lower layer back to the upper layer.

As described in the present example, a menu screen normally has a plurality of hierarchical levels. A plurality of menu items are displayed for each level in a manner allowing selection thereof.

In the present embodiment, a method for determining the display order of the menu items by referring to a command count table will be described. The command count table is provided to indicate information regarding the frequency of execution of each menu item (hereinafter, also referred to as the “execution frequency information”).

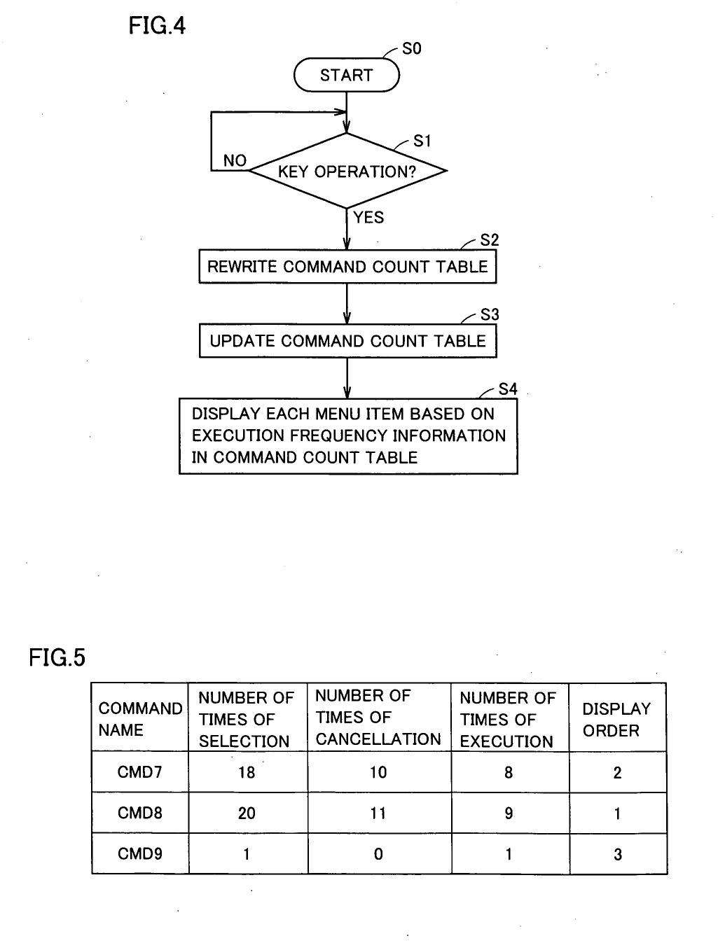

A menu item display method according to the embodiment of the present invention will now be described with reference to FIG. 4.

Referring to FIG. 4, in the menu item display method according to the present embodiment, firstly, it is determined whether there was a key operation (step S1).

If it is determined in step S1 that there was a key operation, a command count table is rewritten (step S2). Specifically, the number of times of selection or the number of times of cancellation is rewritten corresponding to the command or the menu item for which the key operation was made. For example, when the “enter” (select) button is selected by depression as described above, the count of the number of times of selection is incremented by 1 to rewrite the same. When the “return” button is selected by depression, the count of the number of times of cancellation is incremented by 1 to rewrite the same.

The command count table thus rewritten is updated (step S3).

The command count table according to the embodiment of the present invention will now be described with reference to FIG. 5.

The command count table of the present invention stores the number of times of selection, the number of times of cancellation, the number of times of execution and a display order for each menu item.

Here, by way of example, the number of times of selection, the number of times of cancellation, and the number of times of execution corresponding to the respective menu items in the second hierarchical level illustrated in FIG. 3 are shown. Specifically, CMD 7 to CMD 9 are shown as the command names, and the number of times of selection, the number of times of cancellation, the number of times of execution, and the display order are shown corresponding to each of the command names. Here, as the number of times of execution, the actual number of times of execution obtained by subtracting the number of times of cancellation from the number of times of selection is stored in the table.

Referring again to FIG. 4, each menu item is displayed based on the execution frequency information in the command count table (step S4).

Specifically, the display order is set based on the calculated number of times of execution. In the command count table in FIG. 5, among the three commands, command CMD 8 has the greatest number of times of execution, command CMD 7 has the second greatest number, and command CMD 9 has the lowest number.

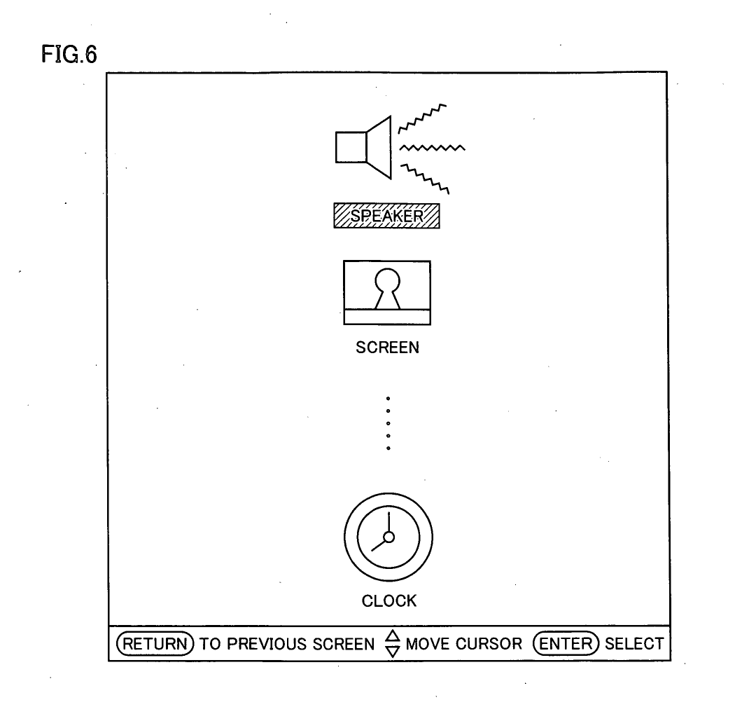

The case where the menu items in the second hierarchical level regarding the setup are displayed in accordance with the updated command count table will now be described with reference to FIG. 6.

As shown in FIG. 6, the menu items are displayed in the order of the speaker corresponding to command CMD 8, the screen corresponding to command CMD 7, and the clock corresponding to command CMD 9. Even in the case where menu items are arranged in the order of command names assigned in advance at the time of shipment, the display order can be changed using the method of the present embodiment, in accordance with the execution frequency by the user. Particularly, with the menu item display method according to the present embodiment, the number of times of execution is calculated, not solely based on the number of times of selection, but also taking account of the number of times of cancellation. That is, the display order can be set based on the number of times of actual execution, by eliminating the case where the user erroneously selected the menu item or made an erroneous operation. Accordingly, it is possible to provide the display of menu items on the menu screen based on the actual execution frequency, and thus, the display satisfying the actual needs of the user is possible, which improves the convenience of the user.

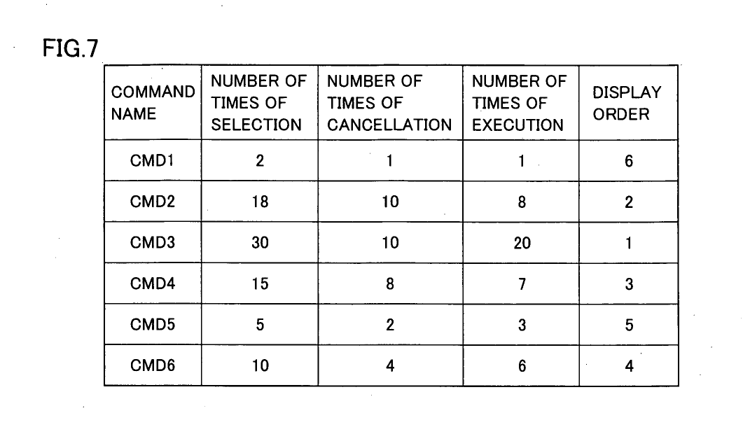

Another command count table according to the embodiment of the present invention will now be described with reference to FIG. 7.

Referring to FIG. 7, the command count table corresponding to command names CMD 1 to CMD 6 is shown.

As shown in FIG. 7, the display order is set in descending order of the number of times of execution. Specifically, the commands are displayed in the order of CMD 3, CMD 2, CMD 4, CMD 6, CMD 5, and CMD 1.

Meanwhile, the number of times of cancellation is great in each of commands CMD 2 and CMD 3. This means that they are once selected but likely to be cancelled thereafter. It is considered that they are commands for which the probability of erroneous operation by the user is high.

Based on the foregoing, it may be configured such that the command of which the number of times of cancellation is great, e.g., the command having the number of times of cancellation that exceeds a prescribed number of times, is displayed in a manner capable of preventing the erroneous operation by the user.

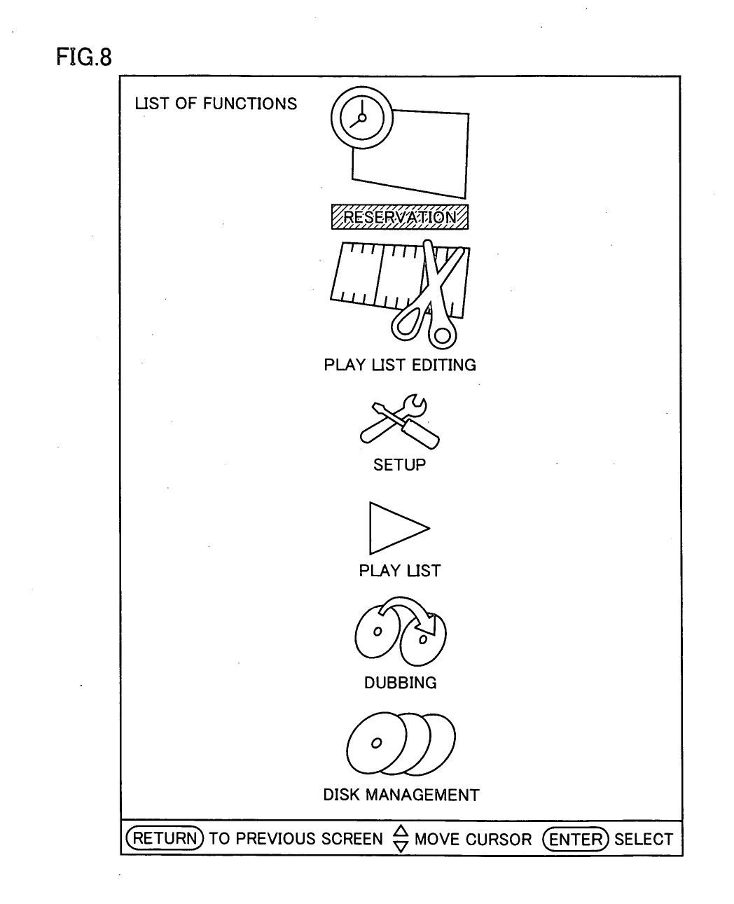

The case of displaying the menu items based on the display order in accordance with the command count table shown in FIG. 7 will now be described with reference to FIG. 8. As described above, the menu items are arranged in the order of “reservation”, “play list editing”, “setup”, “play list”, “dubbing”, and “disk management” corresponding to the order of commands CMD 3, CMD 2, CMD 4, CMD 6, CMD 5, and CMD 1. As to the commands for which the number of times of cancellation is large, the characters and icons displayed are increased in size compared to those for the other commands. As such, for the command of which the number of times of cancellation exceeds a prescribed number, in order to prevent an erroneous operation by the user, the characters may be increased in size, the icon may be increased in size, or, although not shown, the display may be changed in color from that of the remaining commands, so as to increase the visibility of the command for the user to prevent the erroneous operation. As such, it is possible to display the menu items in a manner convenient for the user by using the execution frequency information in the command count table.

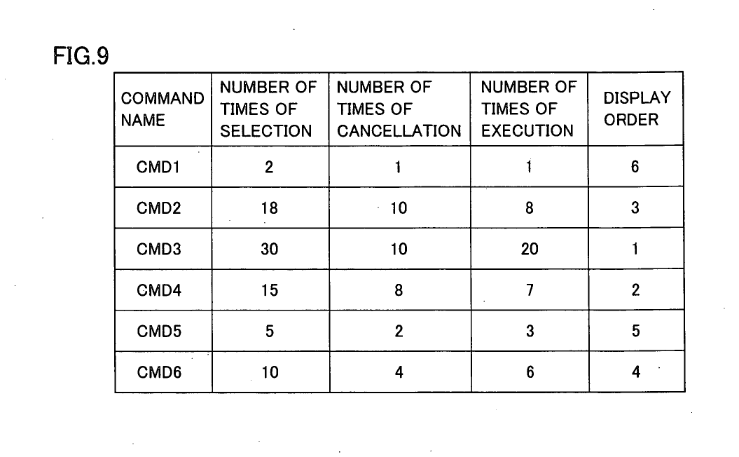

Another command count table according to the embodiment of the present invention will now be described with reference to FIG. 9.

The command count table shown in FIG. 9 differs from the command count table in FIG. 7 in setting of the display order. More specifically, it is set such that command CMD 4 is displayed following command CMD 3, and then command CMD 2 is displayed. In other words, the display order of commands CMD 2 and CMD 4 is reversed.

In the foregoing, the case of setting the display order in descending order of the number of times of execution was explained. Explanation was also made about the point that a command having a great number of times of cancellation may be the command for which the probability of erroneous operation by the user is high.

Thus, if the commands each having a great number of times of cancellation are arranged in series, it means that the commands for which the probability of erroneous operation by the user is high are adjacent to each other. It is considered that such commands are better to be arranged separate from each other.

As such, in the case shown in FIG. 9, by way of example, the commands each having a great number of times of cancellation, i.e., those having the number of times of cancellation that exceeds a prescribed number, are arranged not to be adjacent to each other, by arranging another command having a small number of times of cancellation therebetween, so as to avoid an erroneous operation by the user.

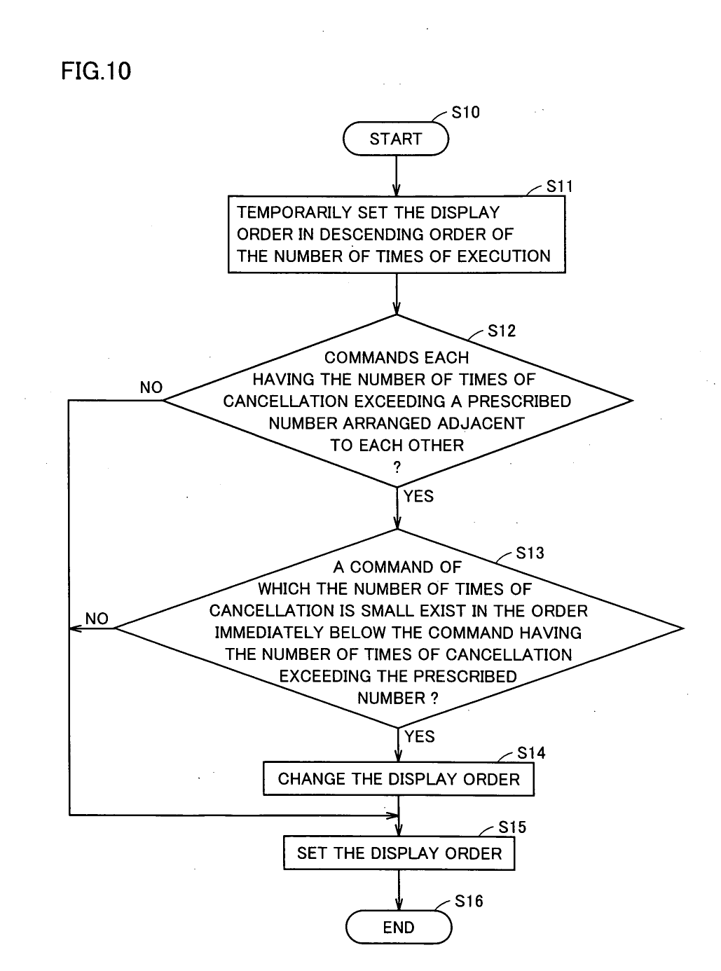

Another way of setting the display order according to the embodiment of the present invention will now be described with reference to FIG. 10.

Referring to FIG. 10, setting of the display order is started based on the number of times of execution by referring to the command count table (START) (step S10).

The display order is temporarily set in descending order of the number of times of execution (step S11).

Next, it is determined whether the commands each having the number of times of cancellation that exceeds a prescribed number are arranged adjacent to each other or not (step S12).

If it is determined in step S12 that such commands having the number of times of cancellation exceeding the prescribed number are arranged adjacent to each other, it is determined whether there exists a command having a small number of times of cancellation in the lower order immediately following the command having the number of times of cancellation exceeding the prescribed number (step S13).

If it is determined in step S13 that there exists the command having a small number of times of cancellation in the lower order immediately following the command having the number of times of cancellation that exceeds the prescribed number, their display order is reversed (step S14), and the display order is set (step S15). The process is thus completed (step S16). In this manner, it is possible to restrict the erroneous operation by the user by arranging a command having a small number of times of cancellation between the commands each having a great number of times of cancellation, i.e., those having the numbers of times of cancellation exceeding a prescribed number such that they are not adjacent to each other.

If it is determined in step S12 that the commands having the numbers of times of cancellation exceeding the prescribed number are not arranged adjacent to each other, the process proceeds to step S15 where the display order is set.

If it is determined in step S13 that there is no command having a small number of times of cancellation in the order lower than and immediately following the commands having the numbers of times of cancellation that exceed the prescribed number, then the process proceeds to step S15 where the display order is set. In this case, it is considered that it will be more convenient for the user to place higher priority to the display order set in descending order of the number of times of execution rather than changing the display order taking account of the number of times of cancellation.

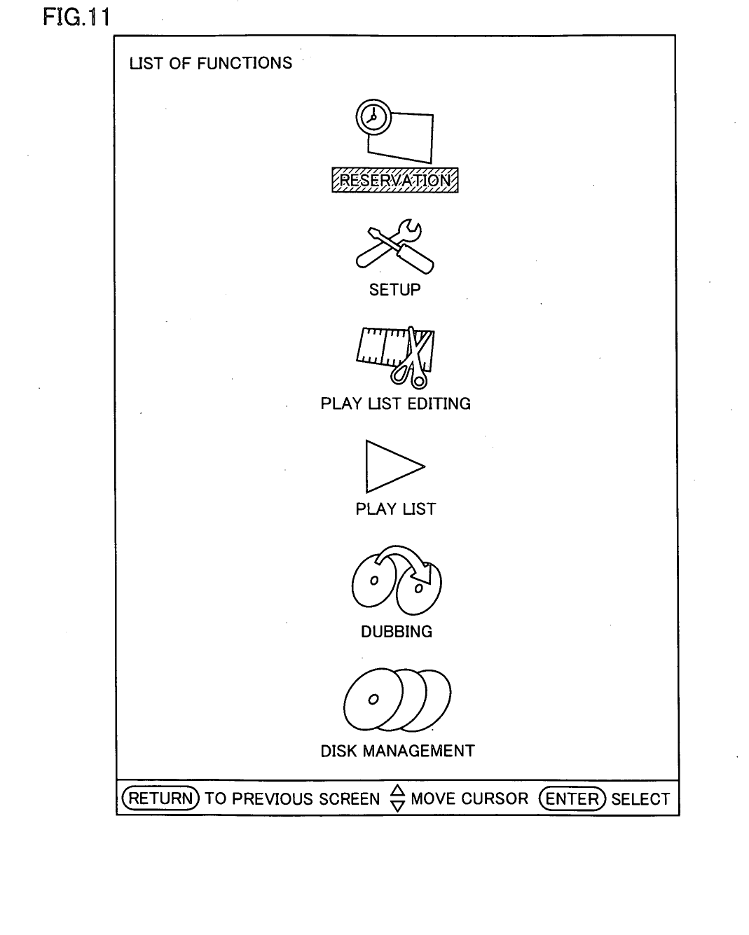

FIG. 11 shows the case where the menu items are arranged in accordance with the display order of the command count table in FIG. 9.

In this manner, the commands each having a great number of times of cancellation, “reservation” and “play list editing”, i.e., those having the number of times of cancellation exceeding a prescribed number, are arranged not to be adjacent with each other, by arranging another command having a small number of times of cancellation therebetween, so that an erroneous operation of the user can be restricted.

It is noted that it is of course possible to combine such a change in display order with the change in size of the characters and/or icons as explained above in conjunction with FIG. 8.

In the above description, the DVD information recording and reproduction apparatus has been explained as an example of the electronic apparatus. Not limited thereto, the present invention is applicable to any other electronic apparatus as long as it has a display of menu items on a display screen for setting of the apparatus.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A menu item display method for displaying a plurality of menu items associated with setting of an electronic apparatus and arranged in a plurality of hierarchical levels by dynamically applying priorities to the menu items in each of the hierarchical levels, comprising the steps of:
selecting, in an upper hierarchical level in said plurality of hierarchical levels, a desired menu item from among a plurality of menu items arranged in a prescribed display order to move to a lower hierarchical level;
canceling selection of said selected menu item to move from the lower hierarchical level back to the upper hierarchical level as required;
recording execution frequency information provided for each hierarchical level and including the number of times of selection and the number of times of cancellation of each of a plurality of menu items in the corresponding hierarchical level on a storage unit provided in said electronic apparatus;
updating, for each hierarchical level, the setting of the display order of said plurality of menu items in the relevant hierarchical level based on the execution frequency information corresponding to the plurality of menu items stored in said storage unit; and
displaying, for each hierarchical level, the plurality of menu items associated with the setting of said electronic apparatus in accordance with the updated display order;
said execution frequency information further including the number of times of execution obtained by subtracting the number of times of cancellation from the number of times of selection of the menu item,
said step of updating including the step of updating the setting of the display order of said plurality of menu items in each hierarchical level in descending order of the number of times of execution in said execution frequency information for each of said menu items, and
said step of displaying including the step of displaying a menu item among said plurality of menu items of which the number of times of cancellation in said execution frequency information is not smaller than a prescribed number, by setting at least one of size and color of said menu item to differ from the size or the color of the remaining menu items of which the number of times of cancellation in said execution frequency information is smaller than the prescribed number.

2. A menu item display method for displaying a plurality of menu items associated with setting of an electronic apparatus and arranged in a plurality of hierarchical levels by dynamically applying priorities to the menu items in each of the hierarchical levels, comprising the steps of:
selecting, in an upper hierarchical level in said plurality of hierarchical levels, a desired menu item from among a plurality of menu items arranged in a prescribed display order to move to a lower hierarchical level;
canceling selection of said selected menu item to move from the lower hierarchical level back to the upper hierarchical level as required;
recording execution frequency information provided for each hierarchical level and including the number of times of selection and the number of times of cancellation of each of a plurality of menu items in the corresponding hierarchical level on a storage unit provided in said electronic apparatus;
updating, for each hierarchical level, the setting of the display order of said plurality of menu items in the relevant hierarchical level based on the execution frequency information corresponding to the plurality of menu items stored in said storage unit; and
displaying, for each hierarchical level, the plurality of menu items associated with the setting of said electronic apparatus in accordance with the updated display order.

3. The menu item display method according to claim 2, wherein
said execution frequency information further includes the number of times of execution obtained by subtracting the number of times of cancellation from the number of times of selection of the menu item, and
said step of updating includes the step of updating the setting of the display order of said plurality of menu items in each hierarchical level in descending order of the number of times of execution in said execution frequency information for each of said menu items.

4. The menu item display method according to claim 2, wherein said step of updating includes the step of updating the setting of the display order of said plurality of menu items such that two of said menu items of which the number of times of cancellation in said execution frequency information is not smaller than a prescribed number are not arranged adjacent to each other.

5. The menu item display method according to claim 2, wherein said step of displaying includes the step of displaying a menu item among said plurality of menu items of which the number of times of cancellation in said execution frequency information is not smaller than a prescribed number, by setting at least one of size and color of said menu item to differ from the size or the color of the remaining menu items of which the number of times of cancellation in said execution frequency information is smaller than the prescribed number.
